(19) United States
(12) Patent Application Publication
(10) Pub. No.: US 2012/0164530 A1
(43) Pub. Date: Jun. 28, 2012

(54) NEGATIVE ELECTRODE FOR NONAQUEOUS ELECTROLYTE SECONDARY BATTERY, METHOD FOR PRODUCING SAME, AND NONAQUEOUS ELECTROLYTE SECONDARY BATTERY

(76) Inventors: Hiroshi Temmyo, Osaka (JP); Masatoshi Nagayama, Osaka (JP)

(21) Appl. No.: 13/394,499

(22) PCT Filed: Feb. 25, 2011
(86) PCT No.: PCT/JP2011/001113

§ 371 Date: Mar. 6, 2012

(30) Foreign Application Priority Data
Jun. 30, 2010 (JP) 2010-149119

(51) Int. Cl. H01M 4/64; H01M 4/82

(52) U.S. Cl. 429/211; 427/598

(57) ABSTRACT

An object of the invention is to provide a negative electrode capable of improving the large current characteristics of a nonaqueous electrolyte secondary battery while maintaining the battery capacity. A negative electrode includes a sheet-like current collector and a negative electrode mixture layer disposed on a surface of the current collector. The negative electrode mixture layer includes graphite particles and ceramic particles interposed between the graphite particles. The mean particle size of the ceramic particles is smaller than that of the graphite particles. In an X-ray diffraction pattern of the negative electrode mixture layer, the ratio R of the intensity I₁₁₀ of a peak attributed to a (110) plane of the graphite particles to the intensity I₀₀₂ of a peak attributed to a (002) plane, i.e., the ratio I₁₁₀/I₀₀₂, is 0.05 or more. The negative electrode mixture layer has a density of 1.1 to 1.8 g/cm³.

### TECHNICAL FIELD

This invention relates to a negative electrode for a nonaqueous electrolyte secondary battery, and particularly to an improvement in a negative electrode mixture layer containing graphite as an active material.

### BACKGROUND ART

Recently, electronic devices have become rapidly portable and cordless, and there is an increased demand for secondary batteries that are small, light-weight, and have high energy density as the power source for driving such devices. Also, in addition to secondary batteries for use in small consumer products, large secondary batteries for use in power storage devices, electric vehicles, etc., are also required to provide high output characteristics, long-term durability, and safety.

Nonaqueous electrolyte secondary batteries include a negative electrode comprising a negative electrode current collector and a mixture layer that is disposed thereon and contains a negative electrode active material; a positive electrode comprising a positive electrode current collector and a mixture layer that is disposed thereon and contains a positive electrode active material such as a transition metal oxide; a separator interposed between the negative electrode and the positive electrode; and a nonaqueous electrolyte. The separator is typically a micro-porous film made of polyolefin. Also, as the negative electrode active material, various carbon materials such as graphite are used.

When graphite is used as an active material in a nonaqueous electrolyte secondary battery, a negative electrode mixture layer is usually produced by forming a coating of a negative electrode mixture and rolling the coating in order to heighten energy density.

As a result of the rolling, in the negative electrode mixture layer, the (002) planes or the planes of the layers of the flaky or other graphite particles become oriented in the direction parallel to the plane of the current collector. Graphite has a layered structure, and upon charge/discharge, lithium ions are inserted into between the layers from the edge portions of the respective layers and extracted from between the layers. Upon charge, the lithium ions are inserted into the negative electrode mixture layer from the direction perpendicular to the plane of the current collector. Thus, if the planes of the layers of the graphite are oriented in the direction parallel to the plane of the current collector, the lithium ions cannot be efficiently inserted from the edge portions of the respective layers of the graphite. Also, upon discharge, the lithium ions cannot be smoothly extracted. In particular, in the case of charge/discharge at a large current, the lithium ions cannot diffuse in the negative electrode mixture layer at a sufficient speed, so that the discharge capacity decreases.

In order to facilitate the insertion or extraction of the lithium ions in the negative electrode mixture layer to improve the large-current input/output characteristics (large current characteristics) of the nonaqueous electrolyte secondary battery, attempts have been made to apply a magnetic field to a graphite-containing mixture layer to orient the planes of the layers of the graphite in the direction perpendicular to the current collector (PTLs 1 to 3).

### CITATION LIST

### Patent Literature

PTL 1: Japanese Laid-Open Patent Publication No. 2003-197182
PTL 2: Japanese Laid-Open Patent Publication No. 2003-197189
PTL 3: Japanese Laid-Open Patent Publication No. 2004-220926

### SUMMARY OF INVENTION

### Technical Problem

PTLs 1 to 3 intend to orient the planes of the layers of the graphite in the negative electrode mixture layer in the direction perpendicular to the current collector by utilizing a magnetic field. However, in the case of the negative electrode mixtures of PTLs 1 to 3, if a magnetic field is applied to a coating of the negative electrode mixture before rolling to orient the graphite and then the negative electrode mixture layer is compressed by rolling or the like, the orientation of the graphite is destroyed. However, if the negative electrode mixture layer is not compressed, the battery capacity cannot be increased. Also, the strength of the mixture layer lowers, and the negative electrode active material or the mixture layer is highly likely to separate from the current collector to cause an internal short-circuit. That is, it is difficult to orient the planes of the layers of the graphite particles toward the direction perpendicular to the current collector while heightening the density of the negative electrode mixture layer. It is therefore difficult to maintain large current characteristics while heightening battery capacity or output.

### Solution to Problem

An object of the invention is to provide a negative electrode capable of improving the large current characteristics of a nonaqueous electrolyte secondary battery while maintaining the battery capacity.

One aspect of the invention relates to a negative electrode for a nonaqueous electrolyte secondary battery, including a sheet-like negative electrode current collector and a negative electrode mixture layer disposed on a surface of the negative electrode current collector, the negative electrode mixture layer including graphite particles and ceramic particles interposed between the graphite particles. The mean particle size of the ceramic particles is smaller than that of the graphite particles. In an X-ray diffraction pattern of the negative electrode mixture layer, the ratio R of the intensity I₁₁₀ of a peak attributed to a (110) plane of the graphite particles to the intensity I₀₀₂ of a peak attributed to a (002) plane, i.e., the ratio I₁₁₀/I₀₀₂, is 0.05 or more, and the negative electrode mixture layer has a density of 1.1 to 1.8 g/cm³.

Another aspect of the invention relates to a method for producing a negative electrode for a nonaqueous electrolyte secondary battery. The method includes the steps of:

dispersing graphite particles and ceramic particles in a liquid medium to form a negative electrode slurry, the mean particle size of the ceramic particles being smaller than that of the graphite particles;

providing a sheet-like negative electrode current collector;

applying the negative electrode slurry onto a surface of the negative electrode current collector to form a negative electrode mixture coating;

applying a predetermined magnetic field to the coating and orienting (002) planes of the graphite particles contained in the coating toward a direction normal to the negative electrode current collector in the magnetic field; and

after orienting the (002) planes of the graphite particles, rolling the coating to form a negative electrode mixture layer with a density of 1.1 to 1.8 g/cm³.

Still another aspect of the invention relates to a nonaqueous electrolyte secondary battery including a positive electrode, the above-described negative electrode, a separator interposed between the positive electrode and the negative electrode, and a nonaqueous electrolyte.

While the novel features of the invention are set forth particularly in the appended claims, the invention, both as to organization and content, will be better understood and appreciated, along with other objects and features thereof, from the following detailed description taken in conjunction with the drawings.

### Advantageous Effects of Invention

According to the invention, even when the density of the mixture layer is increased by compressing the negative electrode mixture layer or the like, the ceramic particles interposed between the graphite particles can suppress the orientation of the graphite particles from being destroyed. As a result, it becomes easy to insert and extract lithium ions from the edge portions of the layer structure of the graphite, which is advantageous to improving large current characteristics. It is therefore possible to provide a nonaqueous electrolyte secondary battery with a high capacity and good large current characteristics.

### BRIEF DESCRIPTION OF DRAWINGS

FIG. 1 is a schematic sectional view of a negative electrode according to one embodiment of the invention; and

FIG. 2 is a longitudinal sectional view of a cylindrical nonaqueous electrolyte secondary battery according to one embodiment of the invention.

### DESCRIPTION OF EMBODIMENTS

The negative electrode for a nonaqueous electrolyte secondary battery according to the invention includes a sheet-like negative electrode current collector and a negative electrode mixture layer disposed on a surface of the negative electrode current collector. The negative electrode mixture layer includes graphite particles and ceramic particles interposed between the graphite particles.

As used herein, “graphite particles” is the general term for particles including a region with a graphite structure. Thus, examples of graphite particles include natural graphites, artificial graphites, and graphitized mesophase carbon. These graphite particles can be used singly or in combination. The graphite particles are preferably highly crystalline.

The diffraction pattern of graphite particles measured by wide-angle X-ray diffraction analysis has a peak attributed to the (101) plane and a peak attributed to the (100) plane. The ratio of the intensity I(101) of the peak attributed to the (101) plane to the intensity I(100) of the peak attributed to the (100) plane preferably satisfies 0.01<I(101)/I(100)<0.25, and more preferably satisfies 0.08<I(101)/I(100)<0.20. The intensity of the peak as used herein refers to the height of the peak.

The mean particle size of the graphite particles is, for example, 5 to 20 μm, preferably 7 to 17 μm, and more preferably 8 to 16 μm. The mean particle size of the graphite particles as used herein refers to the median diameter (D50) in the volume basis particle size distribution of the graphite particles. The volume basis particle size distribution of the graphite particles can be determined, for example, by using a commercially available laser diffraction particle size distribution analyzer.

The average circularity of the graphite particles is preferably 0.90 to 0.95, and more preferably 0.91 to 0.94. When the average circularity is within the above range, the sliding properties of the graphite particles in the negative electrode mixture layer are improved, which is advantageous to improving the packing properties of the graphite particles. The average circularity is expressed as 4πS/L² (S represents the area of the orthogonally projected image of a graphite particle and L represents the length of the circumference of the orthogonally projected image). For example, the average circularity of given 100 graphite particles is preferably in the above range.

The aspect ratio of the graphite particles is, for example, from 1 to 20, preferably from 2 or more (e.g., 2 to 10), and more preferably from 2 to 5. The use of graphite particles with an aspect ratio of 2 or more is effective for controlling the orientation of the graphite particles in the negative electrode mixture layer and is advantageous to improving large current characteristics significantly. As used herein, the aspect ratio refers to the ratio of the largest diameter to the smallest diameter of the graphite particles (largest diameter/smallest diameter).

Examples of the ceramic particles include inorganic oxides and composite oxides including at least one element selected from titanium, aluminum, silicon, magnesium, and zirconium.

In consideration of hardness, chemical stability, costs, etc., for example, titania, alumina, silica, magnesia, or zirconia may be used as the ceramic particles. These ceramic particles can be used singly or in combination.

The crystal structure of the ceramic particles may be, for example, spinel, perovskite, rutile, anatase, or brookite, depending on the kind of the element(s) contained therein.

The ceramic particles may be composite oxides that further include other metal elements than the above-mentioned elements, for example, alkali metal elements such as Li, Na, and K; alkaline earth metal elements such as Ca, Sr, and Ba; transition metal elements such as V, Mo, W, Nb, Mn, Fe, Co, Ni, Cu, and Zn; and the group 13 elements in the periodic table such as B and Ga. These metal elements can be used singly or in combination. Among the metal elements, for example, the alkali metal elements such as lithium and the alkaline earth metal elements are preferable.

In terms of increasing charge/discharge capacity, the preferable ceramic particles are a lithium titanium composite oxide with a spinel crystal structure. Since such composite oxides allow insertion and extraction of lithium ions, they are advantageous to increasing capacity.

Examples of the lithium titanium composite oxide with a spinel crystal structure include lithium titanate represented by the formula Li₄Ti₅O₁₂ and lithium titanates represented by the formula LiₓTi_{5-y}M_{y}O_{12+z} where 3≦x≦5, 0.005≦y≦1.5, and −1≦z≦1.

M is at least one selected from the group consisting of alkali metals such as Na; alkaline earth metals such as Mg, Ca, Sr, and Ba; transition metal elements such as Zr, V, Mo, W, Nb, Mn, Fe, Co, Ni, Cu, and Zn; the group 13 elements in the periodic table such as B, Al, and Ga; and the group 14 elements such as Bi.

The mean particle size of the ceramic particles needs to be smaller than that of the graphite particles in order to suppress the orientation of the graphite particles from being destroyed when the density of the mixture layer is heightened.

The mean particle size of the ceramic particles is, for example, 0.05 to 6 μm, preferably 0.1 to 5 μm, more preferably 0.1 to 2 μm, and particularly 0.5 to 1.5 μm. If the mean particle size of the ceramic particles is larger than that of the graphite particles, it is difficult to increase the ratio of the graphite particles in the negative electrode mixture layer, and the energy density may lower. As used herein, the mean particle size of the ceramic particles refers to the median diameter (D50) in the volume basis particle size distribution of the ceramic particles. The volume basis particle size distribution of the ceramic particles can be determined, for example, by using a commercially available laser diffraction particle size distribution analyzer.

The ratio of the weight W1 of the ceramic particles to the weight W2 of the graphite particles contained in the negative electrode mixture layer, i.e., the ratio (W1/W2), is from 0.01 to 1, preferably from 0.03 to 0.6, and more preferably from 0.05 to 0.4. Such ranges are advantageous in terms of suppressing a decrease in energy density.

The density of the negative electrode mixture layer is 1.1 to 1.8 g/cm³, preferably 1.2 to 1.7 g/cm³, and more preferably 1.25 to 1.6 g/cm³. If the density is too low, the surface roughness of the negative electrode mixture layer increases, so that the separator may be damaged. If the density is too high, it is difficult for lithium ions to be inserted into the negative electrode mixture layer, so that the rate characteristics may lower. The density of the negative electrode mixture layer can be adjusted by changing the degree of compression of the negative electrode mixture layer (the pressure applied for compression, the number of times it is applied, etc).

In the invention, although the negative electrode mixture layer has such a high density as mentioned above, the (002) planes (the ab planes, i.e., the planes of the layers) of many of the graphite particles are oriented toward the direction normal to the negative electrode current collector (the direction perpendicular to the negative electrode current collector) in the negative electrode mixture layer.

The degree of orientation of the graphite particles can be expressed as the ratio between the intensity of the peak attributed to the (002) plane and the intensity of the peak attributed to the (110) plane, which is perpendicular to the (002) plane, in the X-ray diffraction pattern of the negative electrode mixture layer. It should be noted that the more the (002) plane is oriented toward the direction perpendicular to the negative electrode current collector, the lower the intensity of the peak attributed to the (002) plane is.

In the invention, the ratio R of the intensity I₁₁₀ of the peak attributed to the (110) plane to the intensity I₀₀₂ of the peak attributed to the (002) plane, i.e., the ratio R (I₁₁₀/I₀₀₂)), is 0.05 or more, preferably 0.1 or more, more preferably 0.15 or more, or 0.2 or more, or 0.25 or more. As the intensity ratio R increases (as I₀₀₂ lowers), the discharge capacity ratio increases. Thus, the upper limit of the intensity ratio R is not limited, but the intensity ratio R can be, for example, 1 or less, preferably 0.5 or less, and more preferably 0.3 or less. The lower limit and the upper limit can be a combination of values selected from those mentioned above.

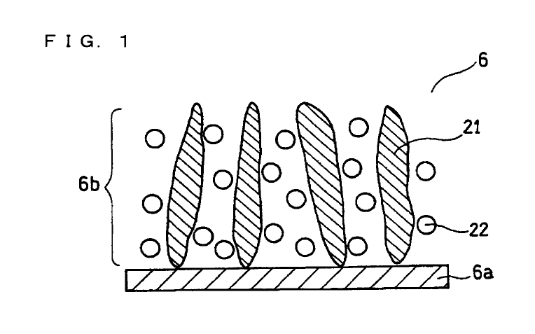

FIG. 1 is a schematic sectional view of a negative electrode according to one embodiment of the invention. As illustrated in FIG. 1, a negative electrode 6 has a negative electrode current collector 6a and a negative electrode mixture layer 6b disposed on a surface of the negative electrode current collector 6a. The negative electrode mixture layer 6b includes flaky graphite particles 21, and the graphite particles 21 are oriented in the direction substantially perpendicular to the surface of the negative electrode current collector 6a. Between the graphite particles 21 are ceramic particles 22 whose mean particle size is smaller than that of the graphite particles 21. In FIG. 1, the other components of the negative electrode mixture layer such as a binder are omitted.

The negative electrode mixture layer can be formed on at least one surface of the negative electrode current collector, and can be formed on both surfaces.

In the invention, the ceramic particles are interposed between the graphite particles in the negative electrode mixture layer. The ceramic particles have high hardness compared with the graphite particles. Thus, even when the negative electrode mixture layer is compressed to the above-mentioned density, the graphite particles do not become disoriented. Since the edge portions of the graphite particles are aligned on the surface of the negative electrode mixture layer, lithium ions can be absorbed and extracted in the direction substantially perpendicular to the surface of the negative electrode mixture layer. In this manner, heightening the ratio of the layers of the graphite particles oriented in the direction perpendicular to the negative electrode current collector facilitates the insertion and extraction of lithium ions, thereby improving large-current characteristics significantly.

The negative electrode mixture layer contains graphite particles as a negative electrode active material, ceramic particles, and a binder. If necessary, the negative electrode mixture layer may further contain a thickener, a conductive agent, etc.

Examples of the binder include fluorocarbon resins such as polytetrafluoroethylene (PTFE), polyvinylidene fluoride (PVDF), and vinylidene fluoride (VDF)-hexafluoropropylene (HFP) copolymers; polyolefin resins such as polyethylene and polypropylene; polyamide resins such as aramid; polyimide resins such as polyimide and polyamide-imide; acrylic resins such as polymethyl acrylate and ethylene-methyl methacrylate copolymers; vinyl resins such as polyvinyl acetate and ethylene-vinyl acetate copolymers; polyethersulfone; polyvinyl pyrrolidone; and rubber materials such as styrene-butadiene rubber and acrylic rubber. These binders can be used singly or in combination.

The ratio of the binder is, for example, 0.01 to 10 parts by weight, and preferably 0.05 to 5 parts by weight per 100 parts by weight of the graphite particles.

As the conductive agent, conductive materials, such as carbon materials that are different from the above-mentioned graphite particles and metal materials, can be used. Examples include carbon blacks such as acetylene black, ketjen black, channel black, furnace black, lamp black, and thermal black; conductive fibers such as carbon fibers and metal fibers; and fluorinated carbon. These conductive agents can be used singly or in combination.

The ratio of the conductive agent is not particularly limited, and is, for example, 0 to 5 parts by weight, and preferably 0.01 to 3 parts by weight per 100 parts by weight of the graphite particles.

Examples of the thickener include cellulose derivatives such as carboxymethyl cellulose (CMC); polyC₂₋₄alkylene glycols such as polyethylene glycol and ethylene oxide-propylene oxide copolymers; polyvinyl alcohol; and soluble modified rubber. These thickeners can be used singly or in combination.

The ratio of the thickener is not particularly limited, and is, for example, 0 to 10 parts by weight, and preferably 0.01 to 5 parts by weight per 100 parts by weight of the graphite particles.

The negative electrode current collector can be an imperforate conductive substrate (e.g., metal foil or a metal sheet), or can be a porous conductive substrate with a plurality of through-holes (e.g., a perforated sheet or expanded metal). Examples of metal materials used to form the negative electrode current collector include stainless steel, nickel, copper, and copper alloys. Among them, for example, copper or copper alloys are preferable.

The thickness of the negative electrode current collector can be selected from, for example, the range of 3 to 50 μm, and is preferably 5 to 30 μm, and more preferably 5 to 20 μm.

The negative electrode of the invention can be produced by the following steps (i) to (v) of:

(i) dispersing graphite particles and ceramic particles in a liquid medium to form a negative electrode slurry;

(ii) providing a sheet-like negative electrode current collector;

(iii) applying the negative electrode slurry onto a surface of the negative electrode current collector to form a negative electrode mixture coating;

(iv) applying a predetermined magnetic field to the coating and orienting (002) planes of the graphite particles contained in the coating toward a direction normal to the negative electrode current collector in the magnetic field; and

(v) after orienting the (002) planes of the graphite particles, rolling the coating to form a negative electrode mixture layer with a density of 1.1 to 1.8 g/cm³.

In the step (i), the liquid medium (dispersion medium) used in the negative electrode slurry is not particularly limited, but examples include water, alcohols such as ethanol, ethers such as tetrahydrofuran, and amides such as dimethylformamide, N-methyl-2-pyrrolidone (NMP), and mixtures thereof.

When a binder, a conductive agent and/or a thickener are used, they are usually added to a negative electrode slurry. The negative electrode slurry usually contains constituent components dissolved or dispersed in a dispersion medium.

The negative electrode slurry can be prepared by conventional methods using a mixer, kneader, etc.

In the step (iii), the negative electrode slurry can be applied to a surface of the current collector by conventional application methods, for example, coating methods using various coaters such as a blade coater, a knife coater, and a gravure coater.

In the step (iv), a predetermined magnetic field is applied to the coating. At this time, the predetermined magnetic field is applied to the coating in such a manner that the direction of the magnetic flux of the magnetic field is substantially perpendicular (e.g., 80 to 90°) to the coating and the plane of the negative electrode current collector. The magnetic field is applied to the coating before the liquid medium (e.g., dispersion medium) volatilizes completely. In this manner, the (002) planes of the graphite particles can be oriented toward the direction normal to the negative electrode current collector.

The magnetic field can be applied by, for example, disposing a magnet near the negative electrode current collector with the coating formed thereon.

The magnetic flux density of the magnetic field is, for example, 0.1 to 3 T, preferably 0.2 to 2.5 T, and more preferably 0.3 to 2 T.

The time of application of the magnetic field is, for example, 0.1 second to 5 minutes, preferably 0.1 second to 1 minute, and more preferably 0.5 to 30 seconds, although it depends on the magnetic flux density.

It is preferable to apply the magnetic field to the coating before the liquid medium (e.g., dispersion medium) is removed from the coating or while the dispersion medium is being removed from the coating. That is, the coating is dried after the (002) planes of the graphite particles are oriented, or, it is dried while the graphite particles are being oriented. When dried, the coating is solidified, and the graphite particles are fixed with the (002) planes oriented toward the direction normal to the negative electrode current collector. The drying may be natural drying, and may be performed with heating or at a reduced pressure. If necessary, the drying may be performed while a current of air is supplied.

In the step (v), the coating (usually dried coating) is compressed to increase the density of the negative electrode mixture layer. For example, the coating is rolled with a pair of rollers to form a negative electrode mixture layer.

The rolling pressure (line pressure) is 500 to 2,500 N/cm, preferably 800 to 2,000 N/cm, and more preferably 1,000 to 1,800 N/cm.

The thickness of the negative electrode mixture layer is, for example, 10 to 60 μm, preferably 12 to 50 μm, and more preferably 15 to 35 μm.

The invention uses graphite particles and ceramic particles whose mean particle size is smaller than that of the graphite particles. Thus, the ceramic particles with a relatively high hardness are interposed between the graphite particles. As such, when the negative electrode mixture layer is compressed, the ceramic particles suppress the orientation of the (002) planes of the graphite particles from being excessively changed from the direction normal to the negative electrode current collector toward the plane direction. Therefore, even after the compression, the orientation of the graphite particles can be maintained and, at the same time, the density of the negative electrode mixture layer can be heightened.

Also, since the negative electrode mixture layer can be compressed, the strength of the negative electrode mixture layer can be increased, and the surface roughness can be reduced. It is thus possible to suppress separation and the like of the mixture layer and suppress an internal short-circuit caused thereby.

The nonaqueous electrolyte secondary battery of the invention includes the above-described negative electrode, a positive electrode, a separator interposed between the positive electrode and the negative electrode, and a nonaqueous electrolyte. Typically, nonaqueous electrolyte secondary batteries include an electrode assembly comprising a positive electrode, a negative electrode, and a separator separating them, which are wound together, and the electrode assembly and a nonaqueous electrolyte are housed in a battery case.

One embodiment of the nonaqueous electrolyte secondary battery according to the invention is hereinafter described with reference to drawings.

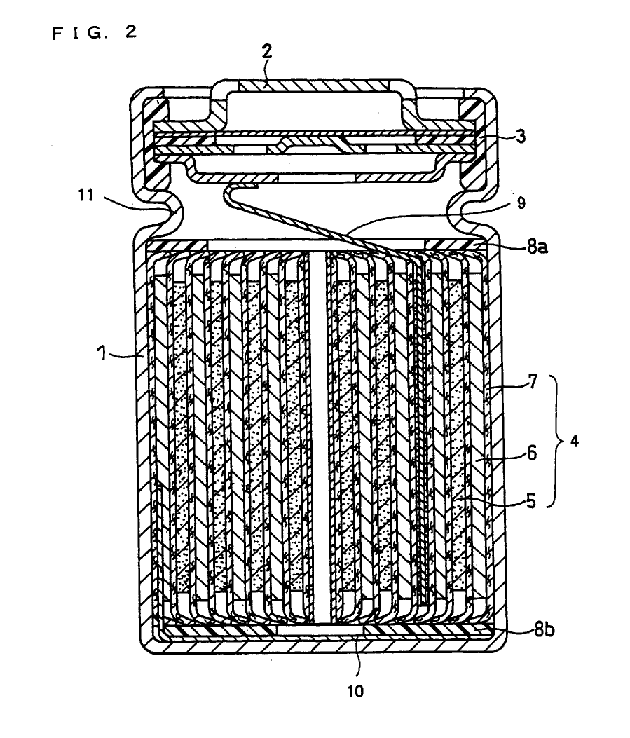

The nonaqueous electrolyte secondary battery of FIG. 2 has an electrode assembly 4 comprising a positive electrode 5 shaped like a long strip, a negative electrode 6 shaped like a long strip, and a separator 7 interposed between the positive electrode 5 and the negative electrode 6, which are wound together. The electrode assembly 4 and a nonaqueous electrolyte (not shown) are housed in a cylindrical metal battery case 1 with a bottom.

The electrode assembly 4 of FIG. 2 is produced by spirally winding the positive electrode 5, the negative electrode 6, and the separator 7 separating them by using a winding core. The winding core may be pulled out, if necessary.

In the electrode assembly 4, the positive electrode 5 is electrically connected with a positive electrode lead 9, while the negative electrode 6 is electrically connected with a negative electrode lead 10. The positive electrode lead 9 can be, for example, an aluminum plate, while the negative electrode lead 10 can be, for example, a nickel plate, a copper plate, or the like.

The electrode assembly 4 with the positive electrode lead 9 drawn therefrom and a lower insulating ring 8b are housed in the battery case 1. The end of the positive electrode lead 9 is welded to a seal plate 2, so that the positive electrode 5 and the seal plate 2 are electrically connected.

The lower insulating ring 8b is disposed between the bottom face of the electrode assembly 4 and the negative electrode lead 10 drawn downward from the electrode assembly 4. The negative electrode lead 10 is welded to the inner bottom face of the battery case 1, so that the negative electrode 6 and the battery case 1 are electrically connected. An upper insulating ring 8a is mounted on the upper face of the electrode assembly 4.

The electrode assembly 4 is retained inside the battery case 1 by a step 11 that is formed in an upper side face of the battery case 1 above the upper insulating ring 8a so as to protrude inward. The seal plate 2 having a resin gasket 3 at the circumference is mounted on the step 11, and the open edge of the battery case 1 is crimped inward for sealing.

The other components of the nonaqueous electrolyte secondary battery are hereinafter described in detail.

### (Positive Electrode)

The positive electrode current collector can be an imperforate conductive substrate (e.g., metal foil or a metal sheet), or can be a porous conductive substrate with a plurality of through-holes (e.g., a perforated sheet or expanded metal). Examples of metal materials used for the positive electrode current collector include stainless steel, titanium, aluminum, and aluminum alloys.

In terms of the strength and weight reduction of the positive electrode, the thickness of the positive electrode current collector can be selected from the range of, for example, 3 to 50 μm, and is preferably 5 to 30 μm, and more preferably 5 to 20 μm.

The positive electrode current collector has a positive electrode mixture layer adhering to a surface thereof. The positive electrode mixture layer may be formed on one surface of the positive electrode current collector, or may be formed on both surfaces.

The positive electrode mixture layer contains a positive electrode active material and a binder. If necessary, the positive electrode mixture layer may further contain a thickener, a conductive agent, etc.

Examples of the positive electrode active material include transition metal oxides commonly used in the field of nonaqueous electrolyte secondary batteries, such as lithium-containing transition metal oxides. The lithium-containing transition metal oxides preferably have a layered or hexagonal crystal structure, or a spinel structure. The positive electrode active material is usually used in the form of particles.

Examples of transition metal elements contained in the transition metal oxides include Co, Ni, and Mn. The transition metals may be partially replaced with different element(s). Also, the particles of the lithium-containing transition metal oxides may be covered with different element(s) at the surface. Examples of the different elements include Na, Mg, Sc, Y, Cu, Zn, Al, Cr, Pb, Sb, and B. These positive electrode active materials can be used singly or in combination.

Specific examples of the positive electrode active material include lithium cobaltate LiₓCoO₂, lithium nickelate LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, and LiₓMn_{2-y}M_{y}O₄ wherein M=at least one of Na, Mg, Sc, Y, Mn, Fe, Co, Ni, Cu, Zn, Al, Cr, Pb, Sb, and B. In the above general formulae, 0<x≦1.2, 0<y0.9, and 2.0≦z≦2.3.

The thickener and conductive agent used for the positive electrode mixture layer can be the same as those mentioned as the thickener and conductive agent for the negative electrode mixture layer.

The ratio of the thickener is not particularly limited, and is, for example, 0 to 10 parts by weight, and preferably 0.01 to 5 parts by weight per 100 parts by weight of the positive electrode active material.

The ratio of the conductive agent is, for example, 0 to 15 parts by weight, and preferably 1 to 10 parts by weight per 100 parts by weight of the positive electrode active material.

The positive electrode can be formed by preparing a positive electrode slurry containing a positive electrode active material and a binder and applying it onto a surface of a positive electrode current collector. The positive electrode slurry usually contains a dispersion medium, and may further contain a thickener and/or a conductive agent. The coating formed on the surface of the positive electrode current collector is usually dried and rolled.

The components (e.g., dispersion medium) used, the ratios thereof, the conditions under which the slurry is prepared and applied, the conditions under which the coating is rolled (e.g., line pressure), etc. are the same as those for the negative electrode. The positive electrode mixture layer can be rolled at a relatively high pressure. In this case, the rolling pressure (line pressure) can be, for example, 1 to 30 kN/cm, preferably 5 to 25 kN/cm, and more preferably 10 to 22 kN/cm.

The separator can be, for example, a resin-containing porous membrane (porous film) or non-woven fabric. The resin used to form the separator can be, for example, a polyolefin resin such as polyethylene, polypropylene, or an ethylene-propylene copolymer. The porous film can contain inorganic oxide particles, if necessary.

The thickness of the separator is, for example, 5 to 100 μm, preferably 7 to 50 μm, and more preferably 10 to 25 μm.

The nonaqueous electrolyte includes a nonaqueous solvent and a lithium salt dissolved therein.

Examples of the nonaqueous solvent include cyclic carbonic acid esters, chain carbonic acid esters, and cyclic carboxylic acid esters. Examples of cyclic carbonic acid esters include ethylene carbonate (EC) and propylene carbonate (PC). Examples of chain carbonic acid esters include diethyl carbonate (DEC), ethyl methyl carbonate (EMC), and dimethyl carbonate (DMC). Examples of cyclic carboxylic acid esters include γ-butyrolactone (GBL) and γ-valerolactone (GVL). These nonaqueous solvents can be used singly or in combination.

Examples of the lithium salt which can be used include lithium salts of fluorine-containing acids (e.g., LiBF₄, and LiCF₃SO₃) and lithium salts of fluorine-containing acid imides (e.g., LiN(CF₃SO₂)₂). These lithium salts can be used singly or in combination. The concentration of the lithium salt in the nonaqueous electrolyte is 0.5 to 2 mol/L.

The nonaqueous electrolyte can contain a known additive, such as vinylene carbonate, cyclohexyl benzene, or diphenyl ether, if necessary.

The electrode assembly is not limited to a wound one, and may be a layered or a fanfolded one. The electrode assembly may have a cylindrical shape or may have such a flat shape that the end faces perpendicular to the winding axis are elliptic, depending on the shape of the battery or battery case.

The battery case may be a laminated film, but it is usually made of a metal in term of the strength to withstand pressure. The materials of the battery case which can be used include aluminum, aluminum alloys (e.g., alloys containing very small amounts of metals such as manganese and copper), and steel. The battery case may be plated, for example, with nickel, if necessary.

The shape of the battery case may be cylindrical or prismatic, depending on the shape of the electrode assembly.

### EXAMPLES

The invention is hereinafter described specifically by way of Examples and Comparative Examples, but the invention is not to be construed as being limited to the following Examples.

### Example 1

A nonaqueous electrolyte secondary battery illustrated in FIG. 2 was produced by the following procedure.

### (1) Preparation of Positive Electrode

A mixture containing lithium nickelate (LiNiO₂) as an active material, acetylene black as a conductive agent, and polyvinylidene fluoride (PVDF) as a binder in a weight ratio of 100:5:4 was mixed with a suitable amount of NMP. The resulting mixture was kneaded in a planetary mixer to form a positive electrode mixture slurry (positive electrode slurry).

The positive electrode slurry was applied onto both surfaces of a positive electrode current collector comprising an aluminum foil (thickness 15 μm, width 100 mm), and dried with a current of air at 80° C. for 20 minutes. The positive electrode current collector with the resulting coatings was rolled at a line pressure of 2000 kgf/cm (19.6 kN/cm) with rollers. In this manner, a positive electrode 5, in which a positive electrode mixture layer was formed on each surface of the positive electrode current collector, was produced. The thickness of each positive electrode mixture layer was 40 μm, and the thickness of the positive electrode 5 was 95 μm.

The positive electrode 5 was cut to a strip with a width of 50 mm and a length of 1000 mm. A predetermined portion of the positive electrode 5 was provided with an exposed portion (not shown) of the positive electrode current collector where no positive electrode mixture layer was formed.

### (2) Preparation of Negative Electrode

A mixture containing artificial graphite (aspect ratio 2) with a mean particle size of 15 μm as an active material, a dispersion of styrene-butadiene copolymer rubber particles (solid content 40% by weight) as a binder, carboxymethyl cellulose as a thickener, and alumina particles (mean particle size 1 μm) in a weight ratio of 100:2.5:1:10 was mixed with a suitable amount of water. The resulting mixture was kneaded in a planetary mixer to form a negative electrode mixture slurry (negative electrode slurry).

A copper foil (thickness 20 μm) was used as a negative electrode current collector. The negative electrode slurry was applied onto a surface of the negative electrode current collector. Thereafter, a neodymium magnet was placed under the negative electrode current collector to apply a magnetic field (magnetic flux density 300 mT) produced by the magnet in such a manner that the direction of the magnetic flux was perpendicular to the plane of the negative electrode current collector, thereby orienting the graphite particles. Subsequently, it was dried with a current of air at 80° C. for 20 minutes.

Likewise, a dry coating with oriented graphite particles was formed on the other surface of the negative electrode current collector. The negative electrode current collector with the coating on each surface was rolled once at a line pressure of 150 kgf/cm (1470 N/cm) with a pair of rollers, to produce a negative electrode 6. At this time, the density of the negative electrode mixture layer was 1.4 g/cm³. The thickness of the negative electrode mixture layer was 50 μm, and the total thickness of the negative electrode 6 was 120 μm. This negative electrode 6 was cut to a strip with a width of 55 mm and a length of 1100 mm.

A predetermined portion of the negative electrode 6 was provided with an exposed portion (not shown) of the negative electrode current collector where no negative electrode mixture layer was formed.

### (3) Fabrication of Electrode Assembly

One end of an aluminum positive electrode lead 9 was welded to the exposed portion of the positive electrode current collector of the positive electrode 5. One end of a nickel negative electrode lead 10 was welded to the exposed portion of the negative electrode current collector of the negative electrode 6. Thereafter, the positive electrode 5, the negative electrode 6, and a separator 7 separating them were laminated and wound to form a spiral electrode assembly 4. The separator 7 was a polyethylene porous film (thickness 20 μm).

### (4) Assembly of Battery

The electrode assembly 4 was sandwiched between an upper insulating ring 8a and a lower insulating ring 8b, and the other end of the negative electrode lead 10 was welded to the inner bottom face of a battery case 1. The other end of the positive electrode lead 9 was welded to the lower face of a seal plate 2. The electrode assembly 4 was placed in the cylindrical battery case 1 with an outer diameter of 18 mm and a length of 65 mm.

A nonaqueous electrolyte was injected into the battery case 1 to impregnate the electrode assembly 4 with the nonaqueous electrolyte at a reduced pressure. The nonaqueous electrolyte used was a liquid electrolyte prepared by dissolving LiPF₆ at a concentration of 1 mol/L in such a solvent that EC/DEC=3/7 (volume ratio).

The battery case 1 was crimped and sealed with a seal plate 2 with a gasket 3 interposed therebetween, to produce a cylindrical lithium ion secondary battery Al.

### Comparative Example 1

A negative electrode was produced in the same manner as in Example 1, except that alumina particles were not used. The density of the negative electrode mixture layer was 1.4 g/cm³. Using the negative electrode, a battery B1 was produced in the same manner as in Example 1.

### Example 2

A negative electrode was produced in the same manner as in Example 1, except that the line pressure applied for rolling was set to 100 kgf/cm (980 N/cm). The density of the negative electrode mixture layer was 1.2 g/cm³. Using the negative electrode, a battery A2 was produced in the same manner as in Example 1.

### Example 3

A negative electrode was produced in the same manner as in Example 1, except that the rolling was performed twice. The density of the negative electrode mixture layer was 1.6 g/cm³. Using the negative electrode, a battery A3 was produced in the same manner as in Example 1.

### Examples 4 to 6

Negative electrodes were produced in the same manner as in Example 1, except that the ratio of the alumina particles per 100 parts by weight of the graphite particles was changed. Using the negative electrodes, batteries A4, A5, and A6a were produced in the same manner as in Example 1.

### Example 7 and Comparative Example 2

Negative electrodes were produced in the same manner as in Example 1, except that the aspect ratio of the graphite particles as the negative electrode active material was changed. Using the negative electrodes, batteries A7 and B2 were produced in the same manner as in Example 1.

### Examples 8 to 11

Negative electrodes were produced in the same manner as in Example 1, except that the mean particle size of the alumina particles as the ceramic particles was changed. Using the negative electrodes, batteries A8 to All were produced in the same manner as in Example 1.

### Examples 12 to 15

Negative electrodes were produced in the same manner as in Example 1, except that silica particles, magnesia particles, zirconia particles, or lithium titanium composite oxide particles (Li₄Ti₅O₁₂) were used instead of the alumina particles. Using the negative electrodes, batteries A12 to A15 were produced in the same manner as in Example 1.

In Table 1, the lithium titanium composite oxide particles are shown as “LiTi type”.

### Comparative Example 3

A negative electrode was produced in the same manner as in Example 1, except that a magnetic field was not applied after the negative electrode mixture was applied onto a surface of the negative electrode current collector. Using the negative electrode, a battery B3 was produced in the same manner as in Example 1.

### [Evaluation]

The respective batteries produced in Examples and Comparative Examples were evaluated in the following manner. (A) Battery capacity

In an environment of 25° C., the batteries were charged at 0.7 C until the closed circuit voltage reached 4.2 V and then charged at 4.2 V until the current value decreased to 0.1 A. Thereafter, the batteries were discharged at 0.2 C until the closed circuit voltage reached 2.5 V. The capacities obtained are shown as battery capacities in Table 1.

### (B) High Output Characteristic

In an environment of 25° C., the batteries were charged at 0.7 C until the closed circuit voltage reached 4.2 V and then charged at 4.2 V until the current value decreased to 0.1 A. Thereafter, the batteries were discharged at 5 C until the closed circuit voltage reached 2.5 V. The percentage (%) of the discharge capacity at 5 C relative to the discharge capacity at 0.2 C was calculated. These percentages (%) are shown in Table 1.

TABLE 1

| | | | | | | I₁₁₀/I₀₀₂ | | | | | |
|---|---|---|---|---|---|---|---|---|---|---|---|
| | | | | | | Before | After | | | | Discharge |
| | Ceramic particles | | Graphite particles | | | application | application | | | Battery | capacity |
| | | Particle | Particle | Aspect | | of magnetic | of magnetic | After | Density | capacity | retention |
| Battery | Kind | size μm | size μm | ratio | W1/W2 | field | field | rolling | g/cm³ | mAh | rate % |
| A1 | Alumina | 1 | 15 | 2 | 0.1 | 0.01 | 0.7 | 0.2 | 1.4 | 1550 | 88 |
| A2 | Alumina | 1 | 15 | 2 | 0.1 | 0.01 | 0.7 | 0.3 | 1.2 | 1570 | 90 |
| A3 | Alumina | 1 | 15 | 2 | 0.1 | 0.01 | 0.7 | 0.1 | 1.6 | 1540 | 84 |
| A4 | Alumina | 1 | 15 | 2 | 0.05 | 0.01 | 0.8 | 0.2 | 1.4 | 1560 | 87 |
| A5 | Alumina | 1 | 15 | 2 | 0.2 | 0.01 | 0.7 | 0.3 | 1.6 | 1550 | 86 |
| A6 | Alumina | 1 | 15 | 2 | 0.4 | 0.01 | 0.6 | 0.3 | 1.8 | 1540 | 84 |
| A7 | Alumina | 1 | 15 | 3 | 0.1 | 0.01 | 0.9 | 0.4 | 1.4 | 1560 | 85 |
| A8 | Alumina | 0.2 | 15 | 2 | 0.1 | 0.01 | 0.7 | 0.1 | 1.4 | 1550 | 81 |
| A9 | Alumina | 0.5 | 15 | 2 | 0.1 | 0.01 | 0.7 | 0.1 | 1.4 | 1550 | 82 |
| A10 | Alumina | 2 | 15 | 2 | 0.1 | 0.01 | 0.6 | 0.3 | 1.4 | 1550 | 81 |
| A11 | Alumina | 5 | 15 | 2 | 0.1 | 0.01 | 0.4 | 0.1 | 1.4 | 1550 | 74 |
| A12 | Silica | 1 | 15 | 2 | 0.1 | 0.01 | 0.7 | 0.2 | 1.4 | 1550 | 88 |
| A13 | Magnesia | 1 | 15 | 2 | 0.1 | 0.01 | 0.7 | 0.2 | 1.4 | 1550 | 87 |
| A14 | Zirconia | 1 | 15 | 2 | 0.1 | 0.01 | 0.7 | 0.2 | 1.4 | 1550 | 87 |
| A15 | LiTi type | 1 | 15 | 2 | 0.1 | 0.01 | 0.7 | 0.2 | 1.4 | 1550 | 88 |
| B1 | — | — | 15 | 2 | — | 0.01 | 0.7 | 0.02 | 1.4 | 1550 | 70 |
| B2 | Alumina | 1 | 15 | 1 | 0.1 | 0.01 | 0.4 | 0.03 | 1.4 | 1530 | 73 |
| B3 | Alumina | 1 | 15 | 2 | 0.01 | 0.01 | — | — | 1.4 | 1540 | 70 |

In Table 1, “particle size” refers to mean particle size, and “density” refers to the density of the negative electrode mixture layer after rolling.

As shown in Table 1, the batteries Al to A15 of Examples 1 to 15 exhibited good high-output characteristics, compared with the battery B3 of Comparative Example 3 to which a magnetic field was not applied. Further, the negative electrodes containing the ceramic particles in their negative electrode mixture layers had I₁₁₀/I₀₀₂ ratios of 0.05 or more, although the densities of their mixture layers after rolling were as high as 1.1 to 1.8 g/cm³, and they exhibited improvements in high output characteristics, compared with the battery B1 of Comparative Example 1 using the negative electrode containing no ceramic particles. Also, the batteries A1 to A15 had high battery capacities and good high-output characteristics, compared with the battery B2 with an I₁₁₀/I₀₀₂ ratio after rolling of 0.03. In the case of using graphites with different aspect ratios, i.e., in a comparison between the battery A1, the battery A7, and the battery B2, the aspect ratios of 2 or more were particularly effective in high output characteristics.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

### INDUSTRIAL APPLICABILITY

The negative electrode of the invention is advantageous in terms of providing a nonaqueous electrolyte secondary battery with a high capacity and good large-current characteristics. The nonaqueous electrolyte secondary battery of the invention can be advantageously used as the power source for driving electronic devices such as notebook personal computers, cellular phones, and digital still cameras and as the power source for power storage devices and electric vehicles which require high output.

### REFERENCE SIGNS LIST

1 Battery Case
2 Seal Plate
3 Gasket
4 Electrode assembly
5 Positive Electrode
6 Negative Electrode
6a Negative Electrode Current Collector
6b Negative Electrode Mixture Layer
7 Separator
8a Upper Insulating Ring
8b Lower Insulating Ring
9 Positive Electrode Lead
10 Negative Electrode Lead
11 Step
12 Graphite particles
22 Ceramic particles

1. A negative electrode for a nonaqueous electrolyte secondary battery, comprising a sheet-like negative electrode current collector and a negative electrode mixture layer disposed on a surface of the negative electrode current collector,
the negative electrode mixture layer including graphite particles and ceramic particles interposed between the graphite particles,
the mean particle size of the ceramic particles being smaller than that of the graphite particles,
the ceramic particles being a lithium titanium composite oxide with a spinel crystal structure,
in an X-ray diffraction pattern of the negative electrode mixture layer, the ratio R of the intensity I₁₁₀ of a peak attributed to a (110) plane of the graphite particles to the intensity I₀₀₂ of a peak attributed to a (002) plane, i.e., the ratio I₁₁₀/I₀₀₂, being 0.05 or more, and the negative electrode mixture layer having a density of 1.1 to 1.8 g/cm³.

2. The negative electrode for a nonaqueous electrolyte secondary battery in accordance with claim 1, wherein the mean particle size of the graphite particles is 5 to 20 μm, and the mean particle size of the ceramic particles is 0.1 to 2 μm.

3. The negative electrode for a nonaqueous electrolyte secondary battery in accordance with claim 1, wherein the mean particle size of the graphite particles is 7 to 17 μm and the mean particle size of the ceramic particles is 0.5 to 1.5 μm.

4. The negative electrode for a nonaqueous electrolyte secondary battery in accordance with claim 1, wherein the graphite particles have an aspect ratio of 2 or more.

5. The negative electrode for a nonaqueous electrolyte secondary battery in accordance with claim 1, wherein the ratio of the weight W1 of the ceramic particles to the weight W2 of the graphite particles contained in the negative electrode mixture layer, i.e., the ratio W1/W2, is from 0.05 to 0.4.

6. The negative electrode for a nonaqueous electrolyte secondary battery in accordance with claim 1, wherein the ceramic particles are at least one selected from the group consisting of titania, alumina, silica, magnesia, and zirconia.

7. (canceled)

8. A method for producing a negative electrode for a nonaqueous electrolyte secondary battery, comprising the steps of:
dispersing graphite particles and ceramic particles in a liquid medium to form a negative electrode slurry, the mean particle size of the ceramic particles being smaller than that of the graphite particles;
providing a sheet-like negative electrode current collector;
applying the negative electrode slurry onto a surface of the negative electrode current collector to form a negative electrode mixture coating;
applying a predetermined magnetic field to the coating and orienting (002) planes of the graphite particles contained in the coating toward a direction normal to the negative electrode current collector in the magnetic field; and
after orienting the (002) planes of the graphite particles, rolling the coating to form a negative electrode mixture layer with a density of 1.1 to 1.8 g/cm³.

9. The method for producing a negative electrode for a nonaqueous electrolyte secondary battery in accordance with claim 8, wherein the step of orienting the (002) planes of the graphite particles is performed before the liquid medium is removed from the coating or while the liquid medium is being removed.

10. A nonaqueous electrolyte secondary battery comprising a positive electrode, the negative electrode of claim 1, a separator interposed between the positive electrode and the negative electrode, and a nonaqueous electrolyte.
